(19) United States
(12) Patent Application Publication
(10) Pub. No.: US 2011/0072444 A1
(43) Pub. Date: Mar. 24, 2011

(54) Device for Adjusting Height of Guiding Bar in Slot-In Optical Disk Drive

(75) Inventors: Yao-Ching Tsai, Guishan Shiang (TW); Jen-Chen Wu, Guishan Shiang (TW)

(73) Assignee: QUANTA STORAGE INC., Guishan Shiang (TW)

(21) Appl. No.: 12/872,328

(22) Filed: Aug. 31, 2010

(30) Foreign Application Priority Data
Sep. 24, 2009 (TW) 098132410

(51) Int. Cl. G11B 17/04

(52) U.S. Cl. 720/623; G9B/17.013

(57) ABSTRACT

A device for adjusting the height of a guiding bar in a slot-in optical disk drive is disclosed. The device is disposed on the guiding bar. One end of the guiding bar is pivoted on the pivot on a base plate in the slot-in optical disk drive, and the other end with a screw hole is protruded by a pin to suspend in the slot-in optical disk drive. The device passes through the screw hole to touch the base plate such that the end, with the pin, of the guiding bar is adjusted the height of the guiding bar by taking the pivot as a fulcrum.

### FIELD OF THE INVENTION

The present invention relates to an optical disk drive, and in particular to a device for adjusting the height of a guiding bar that inlets or ejects the optical disc, of a slot-in optical disk drive.

### BACKGROUND OF THE INVENTION

The slot-in optical disk drive uses the linkage mechanism to link up the guiding bar in order to automatically inlet an inserted optical disc and to guide it to the play position. On the other side, while ejecting the optical disc, the slot-in optical disk drive also uses the linkage mechanism to link up the guiding bar, to push out the optical disc from the slot-in optical disk drive. It's very convenient in using and making a trend for consuming.

FIG. 1 shows a conventional slot-in optical disk drive (10). While inletting the optical disc (D), user needs to insert the optical disc (D) into the slot-in optical disk drive (10) to push the guiding bar (13) between the upper case (11) and the lower case (12), of the slot-in optical disk drive (10). One end of the guiding bar (13) is pivoted on the lower case (12) (not shown in FIG. 1). The other end protruded by a pin (14) surrounding by a rubber wheel (15), is suspended and extended near to the center of the slot-in optical disk drive (10), to touch the side of the optical disc (D). The pin (14) takes the pushing force from the optical disc (D) and rotates the guiding bar (13) activating the sensor (not shown in FIG. 1) in the slot-in optical disk drive (10) to automatically orientate the optical disc (D) to the right position. While ejecting the optical disc (D), the linkage mechanism reversely rotates the guiding bar (13) and uses the pin (14) to push out the optical disc (D) from the slot-in optical disk drive (10).

However, in order to decrease the weight of the conventional slot-in optical disk drive (10), the guiding bar (13) is usually in long slice shape with high slenderness ratio. The distortion of manufacturing and assembling makes the suspended end that is protruded by the pin (14) droop and fails to keep the horizontal extending status. The pin (14) couldn't stay close to the upper case (11) tightly and a gap is formed. Furthermore, the suspended and extended end, protruded by the pin (14), of the guiding bar (13) pushes the optical disc (D) with force while positioning or ejecting it. Repeatedly pushing the optical disc (D) cause the guiding bar (13) to droop from mechanical fatigue. The pin (14) couldn't stay close to the upper case (11) tightly will also form a gap. The optical disc (D) may lodge in the gap and be scraped, when it is obliquely inserted into the slot-in optical disk drive (10). Moreover, the over drooping guiding bar (13) may touch other mechanics causing error function to make the slot-in optical disk drive (10) get stuck. Hence, there are still problems to be solved on the height adjustment of the guiding bar in the conventional slot-in optical disk drive.

### BRIEF SUMMARY OF THE INVENTION

An objective of the present invention is to provide a device for adjusting the height of a guiding bar in a slot-in optical disk drive, which is disposed on the guiding bar to adjust the horizontal height of the guiding bar in order to keep a proper gap with the upper case to avoid a slot-in optical disk drive getting stuck or an optical disc lodging in the gap.

Another objective of the present invention is to provide a device for adjusting the height of a guiding bar in a slot-in optical disk drive, which is made of plastic to reduce the noise of sliding friction, to simplify the structure and to decrease the weight of the device.

In order to achieve the foregoing objectives of the invention, a device for adjusting the height of a guiding bar in a slot-in optical disk drive is disposed on the guiding bar in the slot-in optical disk drive which includes a base plate. One end of the guiding bar is pivoted on the pivot of the base plate and the other end, with a screw hole, is protruded by a pin to suspend in the slot-in optical disk drive. Wherein, the height-adjusting device passes through the screw hole and touches the base plate, to adjust the height of the end, with the pin, of the guiding bar by taking the pivot as a fulcrum.

A further embodiment of the present invention provides a height-adjusting device for adjusting the height of a guiding bar in a slot-in optical disk drive, which is disposed on an ejecting bar. One end of the ejecting bar is pivoted on the pivot under the base plate and the other end protruded by a pin passes through an arc type recess disposed on the base plate to suspend and extend horizontally near to the center of the slot-in optical disk drive. A screw hole is disposed on the ejecting bar, at the position that the ejecting bar gets through above the side of the arc type recess. The device includes a screw and a screw nut, that the screw nut is hitched to the screw hole and the hex socket cap screw is fastened with the screw nut via the screw hole. The length that the screw sticks out from the screw hole adjusts the height of the end, with a pin, of the ejecting bar. The present invention of the device for adjusting the height can be a plastic screw.

### BRIEF DESCRIPTION OF THE DRAWINGS

FIG. 1 is a sectional drawing showing partial side of the conventional slot-in optical disk drive;

FIG. 2 is a pictorial drawing showing the height-adjusting device of the slot-in optical disk drive according to the first embodiment of the invention;

FIG. 3 is an enlarged drawing showing the A section of the height-adjusting device in FIG. 2;

FIG. 4 is a sectional drawing showing side of the line between B and B in FIG. 3;

FIG. 5 is a diagram showing the effect of the height-adjusting device according to the first embodiment of the invention; and

FIG. 6 is a sectional drawing showing side of the height-adjusting device according to the second embodiment of the invention.

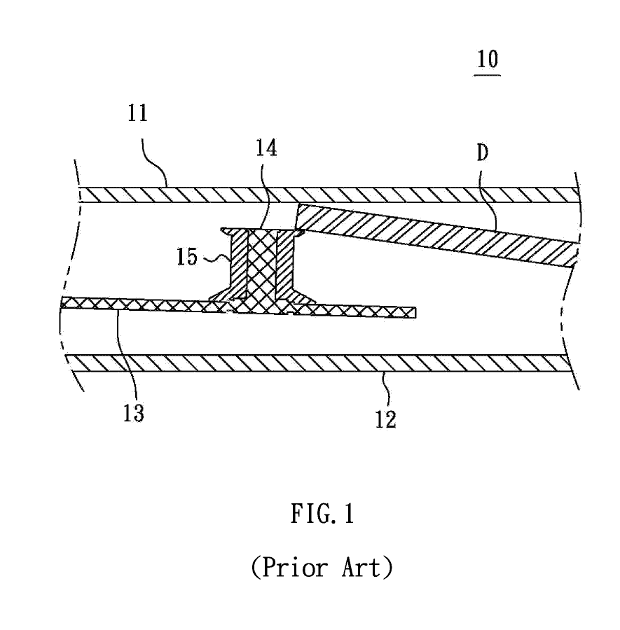

### DETAILED DESCRIPTION OF THE INVENTION

The techniques employed by the present invention to achieve the foregoing objectives and the effects thereof are described hereinafter by way of examples with reference to the accompanying drawings.

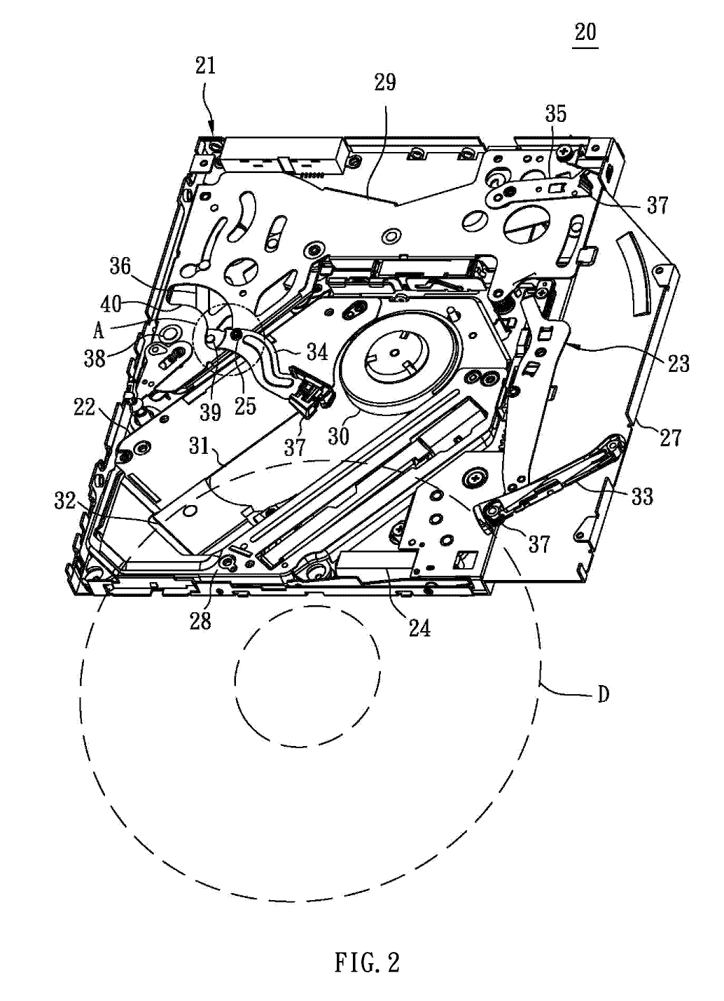

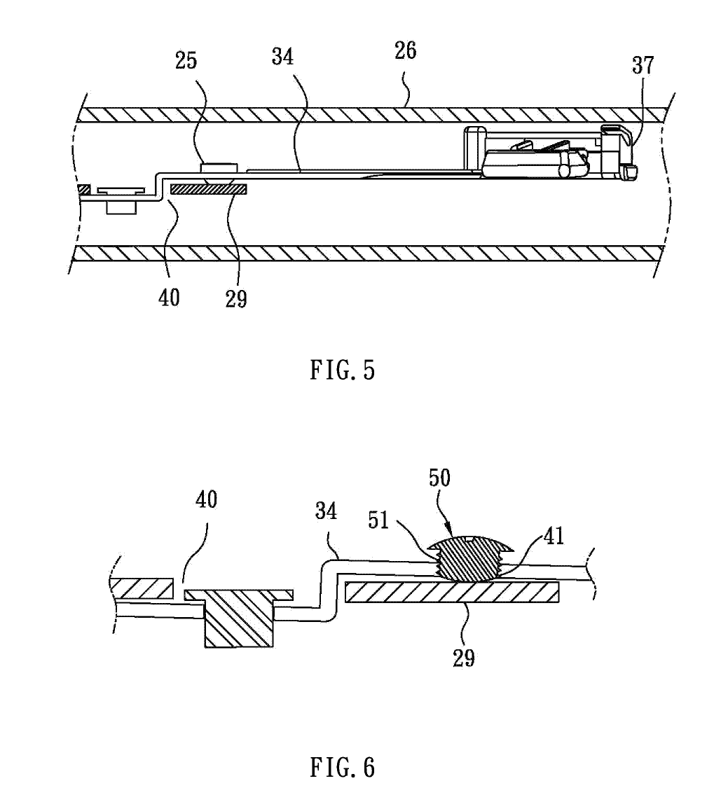

FIG. 2 is a pictorial drawing showing the device for adjusting height of the guiding bar in the slot-in optical disk drive according to the first embodiment of the invention. Referring to FIG. 2, the slot-in optical disk drive (20) includes a case (21), a traverse (22), a linkage (23) for inletting and ejecting, a feeding device (24) and a height-adjusting device (25). The case (21) is a hollow housing that comprises an upper case (referring to FIG. 5), a lower case (27) and an entrance (28) for the optical disc (D) to access, wherein a base plate (29) is fixedly paved on the rear of the lower case (27). One end of the traverse (22) is pivoted on the lower case (27) by the side of the entrance (28), and a spindle (30) is disposed on the other end of the traverse (22) extending horizontally near to the center of the slot-in optical disk drive (20), for rotating the optical disc (D). A long recess (31) is disposed on the traverse (22) along the radial of the spindle (30), for a pick-up head (32) moving back and forth to read or write data on the optical disc (D).

The linkage (23) comprises an inletting bar (33), an ejecting bar (34), an orientation bar (35) and a linkage mechanism (36). The linkage mechanism (36) supported by the base plate (29) while moving is disposed on the lower side of the base plate (29) and drives the inletting bar (33), the ejecting bar (34), pivoted on both sides of the slot-in optical disk drive (20) individually, and the orientation bar (35) pivoted on the rear side of the slot-in optical disk drive (20), by those linkage bars. The inletting bar (33), the ejecting bar (34) and the orientation bar (35) are usually in long slice shape with high slenderness ratio, and the end that is not pivoted on anywhere, is protruded with a pin (37) and suspended and extended to the proper position in the slot-in optical disk drive (20). The feeding device (24) disposed on the side of the traverse (22), provides the power of the slot-in optical disk drive (20) to drive the linkage mechanism (36) and rotate the inletting bar (33), the ejecting bar (34) and the orientation bar (35). The optical disc (D) is guided to inlet or eject by the contact between side of the optical disc (D) and the pin (37) of those bars.

Wherein, one end of the ejecting bar (34) is pivoted on the pivot (38) under the base plate (29) and a point near the pivot (38) connects to the linkage mechanism (36) by a contact (39). The other end protruded by the pin (37), passes through an arc type recess (40) of the base plate (29), suspends above the traverse (22) and extends near to the spindle (30). The ejecting bar (34) is driven by the linkage mechanism (36) via the contact (39), and rotates on the center of the pivot (38) along the arc type recess (40). The height-adjusting device (25) is disposed on the ejecting bar (34).

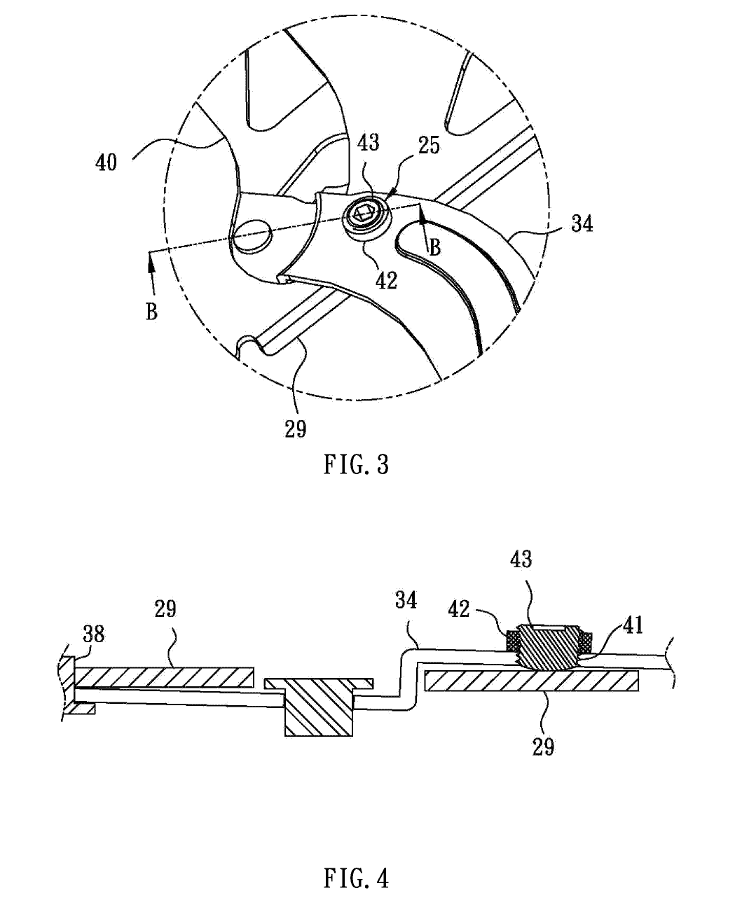

Referring to FIG. 3 and FIG. 4, FIG. 3 is an enlarged drawing showing the A section of the height-adjusting device in FIG. 2, and FIG. 4 is a sectional drawing showing side of the line between B and B in FIG. 3. A screw hole (41) is disposed on the ejecting bar (34), at the position that the ejecting bar (34) crosses above the side of the arc type recess (40). The height-adjusting device (25) includes a screw nut (42) and a screw (43), that the screw nut (42) is hitched on the screw hole (41) and the screw (43) is locked on the screw nut (42). The screw (43) can be a hex socket cap screw to save the mechanical space. The screw (43) passes through the screw hole (41) and could touch the base plate (29) on side of the arc type recess (40).

When the ejecting bar (34) droops because of the manufacturing and assembly tolerance, or mechanical fatigue or loading bending, the screw (43) could be used against the base plate (29) on the side of the arc type recess (40) by tightening the screw (43) and using the pivot (38) that the ejecting bar (34) is pivoted on, and using the length that the screw (43) sticks out from the screw hole (41). FIG. 5 is a diagram showing the effect of the height-adjusting device (25) according to the first embodiment of the invention. Referring to FIG. 5, the height of the end protruded by the pin (37), of the ejecting bar (34) could be adjusted to keep a proper gap between the pin (37) and the upper case (26), to avoid the optical disc lodging in that gap and also to avoid noises and scratches caused by the pin (37) sliding over the upper case (26). Furthermore, the screw (43) of the height-adjusting device (25) could be used to slide over the base plate (29) on side of the arc type recess (40) while the ejecting bar (34) is rotating, and the flat base plate (29) may keep the ejecting bar (34) on a fixed height to avoid getting stuck as a result of touching other components by drooping.

Although the first embodiment of the invention uses a height-adjusting device (25) disposed on the ejecting bar (34) to adjust the height of the ejecting bar (34), it should not be construed as a limitation on the actual applicable scope of the invention. The height-adjusting device (25) can be applied to the inletting bar, orientation bar or any kind of guiding bar that is high slenderness ratio and needs to be adjusted its height. Hence, the device for adjusting the height of a guiding bar in a slot-in optical disk drive according to the invention provides a height-adjusting device disposed on a guiding bar to adjust the horizontal extended height of the guiding bar in order to keep a proper gap between the guiding bar and the upper case and to achieve the objectives of avoiding the slot-in optical disk drive getting stuck or an optical disc lodging in the gap.

FIG. 6 is a sectional drawing showing side of the height-adjusting device (50) according to the second embodiment of the invention. The device for adjusting the height of a guiding bar in a slot-in optical disk drive according to the second embodiment has the same basic structure as it of the device according to the first embodiment. So the same components of both embodiments are labeled in same number to simplify the description. The difference between two devices of both embodiments relating to the height-adjusting device is a screw (51) in the second embodiment, a screw (51) made of plastic in particular. With a thicker ejecting bar (34), the screw (51) could be directly locked in the screw hole (41) of the ejecting bar (34), sticking out from the screw hole (41) by one end against the base plate (29) on side of the arc type recess (40), to adjust the height of the ejecting bar (34). The screw (51) made of plastic not only can decrease the weight, but also reduce the rubbing noises while the screw (51) is rotating with the ejecting bar (34) sliding over the metal base plate (29).

Hence, the device for adjusting the height of a guiding bar in a slot-in optical disk drive according to the invention provides a height-adjusting device formed by a plastic screw to reduce sliding noise, to simplify the structure of the height-adjusting device and to decrease the weight of the slot-in optical disk drive with the lighter plastic screw.

The preferred embodiments of the present invention have been disclosed in the examples. However, the examples should not be construed as a limitation on the actual applicable scope of the invention, and as such, all modifications and alterations without departing from the spirits of the invention and appended claims shall remain within the protected scope and claims of the invention.

What is claimed is:

1. A device for adjusting the height of a guiding bar in a slot-in optical disk drive, the device disposed on the guiding bar in the slot-in optical disk drive comprising a base plate, one end of the guiding bar pivoted on the pivot of the base plate and the other end, with a screw hole, protruded by a pin to suspend in the slot-in optical disk drive, wherein the device passes through the screw hole and touches the base plate, to adjust the height of the end, with the pin, of the guiding bar by taking the pivot as a fulcrum.

2. A device for adjusting the height of a guiding bar in a slot-in optical disk drive according to claim 1, wherein the device hitches a screw nut to the screw hole and the screw nut is fastened by a screw via the screw hole.

3. A device for adjusting the height of a guiding bar in a slot-in optical disk drive according to claim 2, wherein the screw is a hex socket cap screw.

4. A device for adjusting the height of a guiding bar in a slot-in optical disk drive according to claim 2, wherein the screw adjusts the height of the end, with a pin, of the guiding bar by the length that the screw sticks out from the screw hole.

5. A device for adjusting the height of a guiding bar in a slot-in optical disk drive according to claim 1, wherein the guiding bar is an ejecting bar.

6. A device for adjusting the height of a guiding bar in a slot-in optical disk drive according to claim 5, wherein an arc type recess is disposed on the base plate, and one end of the ejecting bar is pivoted on the pivot under the base plate, that the other end protruded by a pin passes through the arc type recess of the base plate to suspend and extend horizontally near to the center of the slot-in optical disk drive, and a screw hole is disposed on the ejecting bar, at the position that the ejecting bar crosses above the side of the arc type recess.

7. A device for adjusting the height of a guiding bar in a slot-in optical disk drive according to claim 6, wherein the ejecting bar rotates along the arc type recess, by taking the pivot as a fulcrum, in order to make the device pass through the screw hole and touch the base plate on side of the arc type recess while sliding.

8. A device for adjusting the height of a guiding bar in a slot-in optical disk drive according to claim 1, wherein the device is a screw.

9. A device for adjusting the height of a guiding bar in a slot-in optical disk drive according to claim 8, wherein the screw is made of plastic.

10. A device for adjusting the height of a guiding bar in a slot-in optical disk drive according to claim 1, wherein the guiding bar is an orientation bar.

11. A device for adjusting the height of a guiding bar in a slot-in optical disk drive according to claim 1, where in the guiding bar is an inletting bar.
